(19) United States
(12) Patent Application Publication
(10) Pub. No.: US 2019/0147791 A1
(43) Pub. Date: May 16, 2019

(54) DISPLAY DEVICE, CONTROL METHOD, AND NON-TRANSITORY COMPUTER-READABLE RECORDING MEDIUM

(71) Applicant: SHARP KABUSHIKI KAISHA, Sakai City (JP)

(72) Inventor: HIROKI ONOUE, Sakai City (JP)

(21) Appl. No.: 16/184,790

(22) Filed: Nov. 8, 2018

(30) Foreign Application Priority Data
Nov. 10, 2017 (JP) 2017-217075

(51) Int. Cl. G09G 3/20; G09G 5/04; G09F 19/12; G09F 9/30

(52) U.S. Cl. CPC G09G 3/2092; G09G 5/04; G09G 5/38; G09F 9/301; G09F 19/12

(57) ABSTRACT

A display device is provided with a display panel and a controller. The display panel displays an image. The controller controls the display panel such that a specific part of the display panel is see-through. The controller controls the display panel such that at least one of the position, mode, and size of the specific part of the display panel changes.

### BACKGROUND

### 1. Field

The present disclosure relates to a display device, a control method, and a non-transitory computer-readable recording medium.

### 2. Description of the Related Art

The display system described in Japanese Unexamined Patent Application Publication (Translation of PCT Application) No. 2014-503835 includes a transparent display panel. The transparent display panel displays an image.

However, with the display system described in Japanese Unexamined Patent Application Publication (Translation of PCT Application) No. 2014-503835, by displaying an image on the transparent display panel, the transparent display panel merely is made to function as digital signage. In other words, the characteristics of the transparent display panel, namely that the panel is transparent, are not utilized sufficiently.

Accordingly, the inventor of the present disclosure has focused on sufficiently utilizing the characteristics of a transparent display panel and further improving the functions of a transparent display panel as digital signage.

Accordingly, it is desirable to provide a display device, a control method, and a non-transitory computer-readable recording medium capable of improving the functions of a display panel as digital signage.

### SUMMARY

According to a first aspect of the present disclosure, there is provided a display device including a display panel and a controller. The display panel displays an image. The controller controls the display panel such that a specific part of the display panel is see-through.

According to a second aspect of the present disclosure, there is provided a control method including setting a specific part with respect to a display panel, and controlling the display panel such that the specific part is see-through.

According to a third aspect of the present disclosure, there is provided a non-transitory computer-readable recording medium storing a computer program causing a computer to execute a process including setting a specific part with respect to a display panel, and controlling the display panel such that the specific part is see-through.

### BRIEF DESCRIPTION OF THE DRAWINGS

FIG. 1 is a diagram illustrating an example operation of a display system according to Embodiment 1 of the present disclosure;

FIG. 2A is a diagram illustrating a change in the position of the specific part according to Embodiment 1, FIG. 2B is a diagram illustrating a change in the mode of the specific part according to Embodiment 1, and FIG. 2C is a diagram illustrating a change in the size of the specific part according to Embodiment 1;

FIG. 3 is a function block diagram illustrating the display system according to Embodiment 1;

FIG. 4 is a flowchart illustrating a control method according to Embodiment 1;

FIG. 5 is a flowchart illustrating a transparency setting process according to Embodiment 1;

FIG. 6 is a flowchart illustrating a transparency process according to Embodiment 1;

FIG. 7 is a flowchart illustrating a panel driving process according to Embodiment 1;

FIG. 8A is a diagram illustrating an example operation of a display system according to Embodiment 2 of the present disclosure, and FIG. 8B is a diagram illustrating another example operation of the display system according to Embodiment 2;

FIG. 9 is a flowchart illustrating a process when a display device according to Embodiment 2 receives input from a user;

FIG. 10 is a flowchart illustrating a control method according to Embodiment 2;

FIG. 11 is a flowchart illustrating a transparency process according to Embodiment 2;

FIG. 12 is a diagram illustrating an example operation of a display system according to Embodiment 3 of the present disclosure;

FIG. 13 is a function block diagram illustrating the display system according to Embodiment 3;

FIG. 14 is a flowchart illustrating a control method according to Embodiment 3;

FIG. 15 is a flowchart illustrating a detection signal process according to Embodiment 3;

FIG. 16 is a flowchart illustrating a transparency setting process according to Embodiment 3;

FIG. 17 is a diagram illustrating an example operation of a display system according to Embodiment 4 of the present disclosure;

FIG. 18 is a function block diagram illustrating the display system according to Embodiment 4;

FIG. 19A is a diagram illustrating a first sight line angle according to Embodiment 4, and FIG. 19B is a diagram illustrating a second sight line angle according to Embodiment 4;

FIG. 20 is a flowchart illustrating a detection signal process according to Embodiment 4; and

FIG. 21 is a flowchart illustrating a transparency setting process according to Embodiment 4.

### DESCRIPTION OF THE EMBODIMENTS

Hereinafter, embodiments of the present disclosure will be described with reference to the drawings. Note that in the drawings, portions which are identical or equivalent will be denoted with the same reference signs, and description thereof will not be repeated. Also, in the embodiments, the X axis and the Z axis are approximately parallel to the horizontal direction, the Y axis is approximately parallel to the vertical direction, and the X, Y, and Z axes are orthogonal to each other.

### Embodiment 1

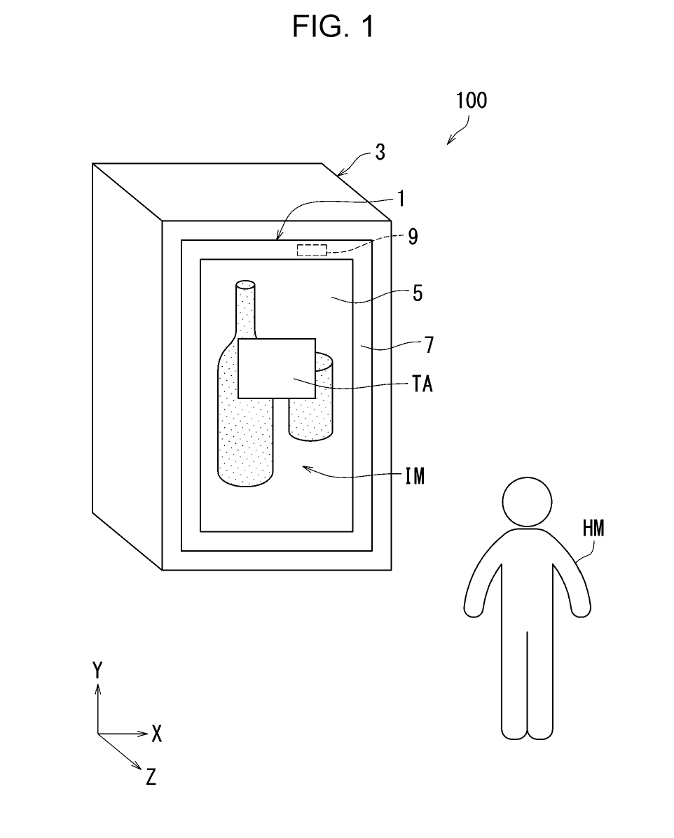

FIGS. 1 to 7 will be referenced to describe a display system 100 according to Embodiment 1 of the present disclosure. First, FIG. 1 will be referenced to describe an example operation of the display system 100. FIG. 1 is a diagram illustrating an example operation of the display system 100. As illustrated in FIG. 1, the display system 100 is provided with a display device 1 and a body 3. In Embodiment 1, the display device 1 and the body 3 constitute a housing device (for example, a refrigerated showcase). The body 3 is approximately box-shaped, and houses objects (for example, products). The display device 1 is openable and closable with respect to the body 3, and constitutes a door.

The display device 1 includes a display panel 5, a frame 7, and a controller 9. The display panel 5 displays an image IM. When not displaying the image IM, the display panel 5 is transparent and see-through. “Transparent” means colorless transparency, semi-transparency, or tinted transparency. In other words, “transparent” means that of the front side and back side of the display panel 5, an object positioned on the back side of the display panel 5 is visible from the front side. The display panel 5 is a liquid crystal display (LCD) panel or an organic electroluminescence (EL) panel, for example. The frame 7 supports the display panel 5.

The display panel 5 is formed by transparent electrodes, a transparent substrate, and a transparent material layer (such as a liquid crystal layer or an organic electroluminescence (EL) layer), for example. There are a variety of basic principles by which the display panel 5 may be configured to be see-through, but the present disclosure is applicable irrespectively of the type of basic principle. For example, the display panel 5 may be a transmissive LCD panel having a configuration in which a backlight is provided at a position (for example, a wall face inside the body 3) not facing opposite the back of the display face of the display panel 5. Alternatively, for example, the display panel 5 may be a self-luminous OLED panel. Hereinafter, an example of using a transmissive LCD panel as the display panel 5 will be described.

The controller 9 controls the display panel 5 such that the display panel 5 displays the image IM. The controller 9 is disposed inside the frame 7, for example. The controller 9 controls the display panel 5 such that a specific part TA of the display panel 5 is see-through.

As described above with reference to FIG. 1, according to Embodiment 1, by displaying the image IM on the display panel 5, the display panel 5 may be made to function as digital signage. In addition, the specific part TA of the display panel 5 is see-through. Consequently, the specific part TA draws the attention of the human being HM, and the human being HM points one's sight line at not only the image IM but also the specific part TA. As a result, the specific part TA functions as digital signage, and the function of the display panel 5 as digital signage may be improved.

For example, the human being HM positioned on the front side of the display panel 5 is able to look through the specific part TA to see an object positioned on the back side of the display panel 5. In other words, the specific part TA guides the sight line to the object positioned on the back side of the display panel 5. Consequently, the specific part TA functions as digital signage for the object.

In particular, since a part of the image IM becomes transparent by the specific part TA, the specific part TA is more noticeable. Consequently, the specific part TA further draws the attention of the human being HM. As a result, the specific part TA functions as digital signage, and the function of the display panel 5 as digital signage may be improved.

Also, according to Embodiment 1, since the specific part TA is see-through while the image IM is also displayed, it is possible to satisfy both the want of a human being close to the display panel 5 and the want of a human being far away from the display panel 5. The want of a human being who is close is to see an object positioned on the back side of the display panel 5 (for example, an object housed in the body 3). On the other hand, the want of a human being who is far away is to see the image IM displayed on the display panel 5.

Specifically, a human being who is close is able to look through the specific part TA and see an object positioned on the back side of the display panel 5. On the other hand, a human being who is far away is able to see the image IM displayed on the display panel 5.

For example, a human being is able to look through the specific part TA and see a product positioned on the back side of the display panel 5. Consequently, the specific part TA functions as a promotional and advertising tool for the product with respect to a human being who is close to the display panel 5. On the other hand, for example, the display panel 5 is able to display the image IM for promotional and advertising purposes. Consequently, the display panel 5 functions as a promotional and advertising tool with respect to a human being who is far away from the display panel 5.

Furthermore, in Embodiment 1, the controller 9 preferably controls the display panel 5 such that at least one of the position, mode, and size of the specific part TA of the display panel 5 changes. In this specification, the “mode” of the specific part TA refers to the appearance or form of the specific part TA, and includes the shape of the specific part TA, for example.

When at least one of the position, mode, and size of the specific part TA is changed, the specific part TA further draws the attention of the human being HM. Consequently, the sight line of the human being HM may be guided to the specific part TA effectively. As a result, the specific part TA may be made to function as digital signage even more effectively.

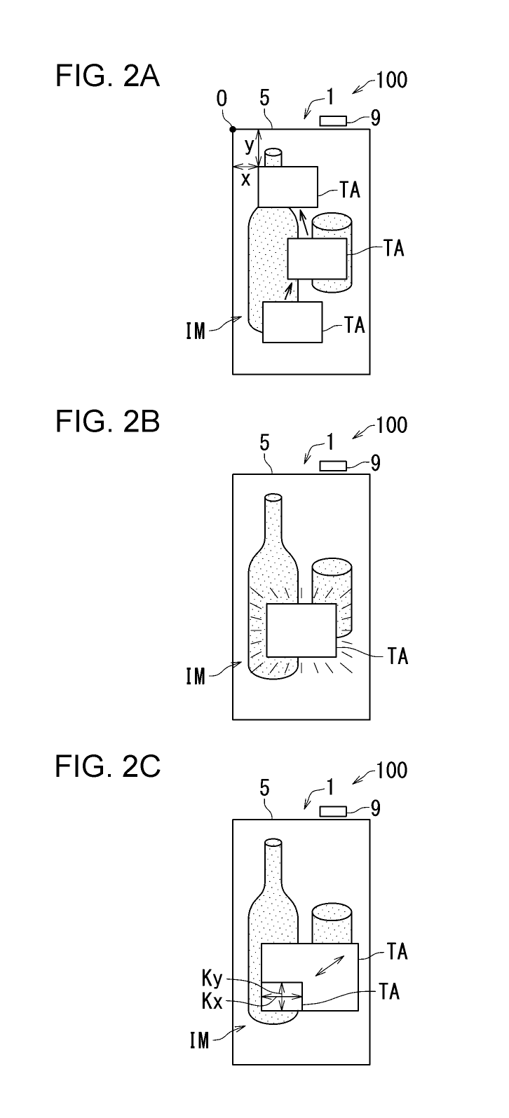

Next, FIGS. 2A to 2C will be referenced to describe control in which the position of the specific part TA changes, control in which the mode of the specific part TA changes, and control in which the size of the specific part TA changes.

FIG. 2A is a diagram illustrating a change in the position of the specific part TA. As illustrated in FIG. 2A, the controller 9 controls the display panel 5 such that the position of the specific part TA acting as a see-through region changes. As a result, the specific part TA moves. The specific part TA has an approximately rectangular shape, for example. The position of the specific part TA is indicated by coordinates (x, y), for example. For example, the coordinates (x, y) indicate the position of one corner of the specific part TA. The coordinates (x, y) indicate coordinates in a two-dimensional orthogonal coordinate system set in the display panel 5. A coordinate origin O is set at the point of intersection between one side edge and the top edge of the display panel 5. Note that the display panel 5 has a top edge, a bottom edge, and a pair of side edges.

FIG. 2B is a diagram illustrating a change in the mode of the specific part TA. As illustrated in FIG. 2B, the controller 9 controls the display panel 5 such that the mode of the specific part TA acting as a see-through region changes. As a result, the mode of the specific part TA changes.

In FIG. 2B, as one example of a “change in the mode”, the specific part TA repeatedly appears and disappears. Also, as another example of a “change in the mode”, the shape of the specific part TA changes from a first shape (for example, a rectangular shape) to a second shape (for example, a circular shape).

FIG. 2C is a diagram illustrating a change in the size of the specific part TA. As illustrated in FIG. 2C, the controller 9 controls the display panel 5 such that the size of the specific part TA acting as a see-through region changes. As a result, the size of the specific part TA changes. The size of the specific part TA is indicated by the dimensions or the area of the specific part TA, for example. For example, in the case in which the specific part TA has an approximately rectangular shape, the size of the specific part TA is indicated by a horizontal width Kx and a vertical width Ky as the dimensions.

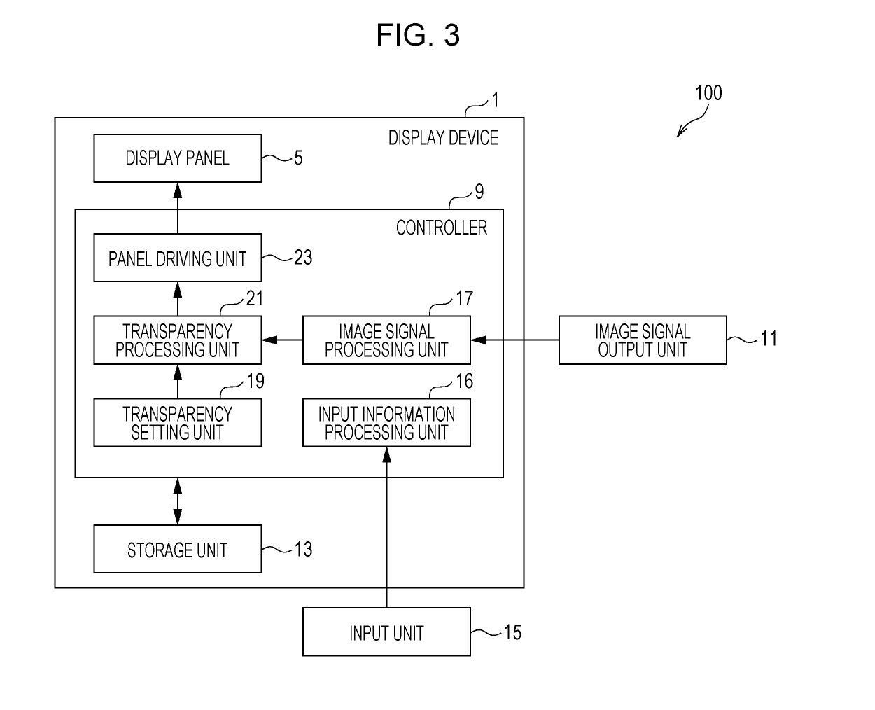

Next, FIG. 3 will be referenced to describe the display system 100. FIG. 3 is a function block diagram illustrating the display system 100. As illustrated in FIG. 3, the display system 100 preferably is provided with an image signal output unit 11 and an input unit 15 in addition to the display device 1. The image signal output unit 11 outputs an analog or digital image signal to the controller 9 of the display device 1. The image signal may include a moving image or a still image. The image signal output unit 11 includes a personal computer or a television receiver, for example.

The input unit 15 receives the input of information from a user, and outputs an input signal including the received information to the controller 9. The input unit 15 includes various operation buttons, for example.

The display device 1 preferably additionally includes a storage unit 13 in addition to the display panel 5 and the controller 9. The storage unit 13 stores data and computer programs. For example, the storage unit 13 temporarily stores data relevant to each process of the controller 9, and stores settings data for the display device 1. The storage unit 13 includes storage devices (a main storage device and an auxiliary storage device), such as memory and a hard disk drive, for example. The storage unit 13 may also include removable media.

The controller 9 includes an image signal processing unit 17, a transparency setting unit 19, a transparency processing unit 21, and a panel driving unit 23. The controller 9 preferably additionally includes an input information processing unit 16.

The input information processing unit 16 receives an input signal output by the input unit 15. Additionally, the input information processing unit 16 processes the input signal, and changes the state of the display device 1 according to an input processing algorithm. Changing the state of the display device 1 includes causing the storage unit 13 to store data, for example.

The image signal processing unit 17 receives an image signal output by the image signal output unit 11. Additionally, the image signal processing unit 17 executes image processing (for example, spatiotemporal filter processing) on the image signal, and outputs the processed image signal to the transparency processing unit 21.

The transparency setting unit 19 sets the specific part TA on the display panel 5. Specifically, the transparency setting unit 19 decides the position, mode, and size of the specific part TA such that at least one of the position, mode, and size of the specific part TA of the display panel 5 changes. Additionally, the transparency setting unit 19 outputs information indicating the position of the specific part TA, information indicating the mode of the specific part TA, and information indicating the size of the specific part TA to the transparency processing unit 21. Note that the information indicating the mode of the specific part TA may also indicate that a mode of the specific part TA does not exist, or in other words, that the specific part TA does not exist.

Hereinafter, in this specification, the information indicating the position of the specific part TA will be designated “position information”, the information indicating the mode of the specific part TA will be designated “mode information”, and the information indicating the size of the specific part TA will be designated “size information”.

On the basis of the position information, mode information, and size information about the specific part TA, the transparency processing unit 21 specifies the region corresponding to the specific part TA (hereinafter designated the “transparency target region”) in the image indicated by the image signal from the image signal processing unit 17. Subsequently, the transparency processing unit 21 sets the transparency target region to a transparent color. A “transparent color” means colorless transparency, semi-transparency, or tinted transparency. Furthermore, the transparency processing unit 21 outputs, to the panel driving unit 23, image data indicating an image after setting the transparency target region to a transparent color.

The panel driving unit 23 drives the display panel 5 such that the display panel 5 displays the image indicated by the image data. As a result, the display panel 5 displays an image while also causing the specific part TA to be see-through.

Note that the controller 9 includes an image processing circuit, a display driver, and a processor, for example. Additionally, for example, the image signal processing unit 17 is realized by the image processing circuit, while the panel driving unit 23 is realized by the display driver. Also, by executing computer programs stored in the storage unit 13, the processor functions as the transparency setting unit 19 and the transparency processing unit 21. Also, the controller 9 constitutes a computer.

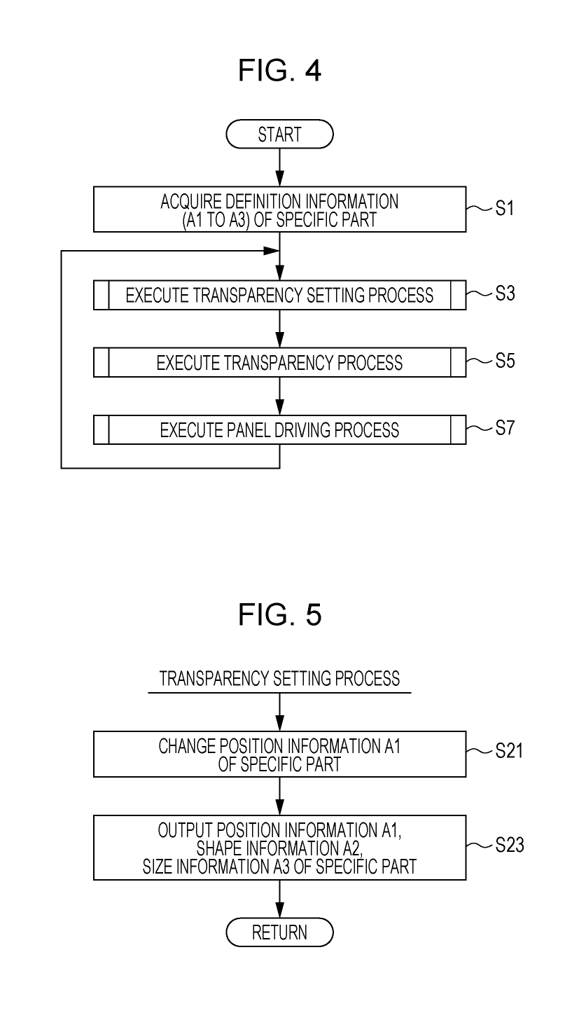

Next, FIGS. 3 and 4 will be referenced to describe a control method executed by the controller 9 of the display device 1. FIG. 4 is a flowchart illustrating the control method. As illustrated in FIG. 4, the control method includes steps S1 to S7. For example, a computer program stored in the storage unit 13 causes the controller 9 to execute the control method.

As illustrated in FIGS. 3 and 4, in step S1, the transparency setting unit 19 acquires definition information about the specific part TA from the storage unit 13. The definition information about the specific part TA indicates information for prescribing the specific part TA. Specifically, the definition information about the specific part TA includes position information A1, mode information A2, and size information A3 about the specific part TA.

In step S3, the transparency setting unit 19 executes a transparency setting process. Step S3 corresponds to “setting the specific part TA with respect to the display panel 5”, for example. In step S5, the transparency processing unit 21 executes a transparency process. Step S5 corresponds to “controlling the display panel 5 such that the specific part TA of the display panel 5 is see-through”, for example. In step S7, the panel driving unit 23 executes a panel driving process. After step S7, the process proceeds to step S3.

Next, FIGS. 3 and 5 will be referenced to describe step S3 of FIG. 4. FIG. 5 is a flowchart illustrating the transparency setting process in step S3 of FIG. 4. FIG. 5 illustrates the transparency setting process when executing control in which the position of the specific part TA changes. As illustrated in FIG. 5, the transparency setting process includes steps S21 and S23.

As illustrated in FIGS. 3 and 5, in step S21, the transparency setting unit 19 changes the position information A1 of the specific part TA according to an algorithm that moves the specific part TA.

In step S23, the transparency setting unit 19 outputs the changed position information A1 of the specific part TA as well as the mode information A2 and the size information A3 of the specific part TA to the transparency processing unit 21.

Note that when executing control in which the mode of the specific part TA changes, in step S21, the transparency setting unit 19 changes the mode information A2 of the specific part TA according to an algorithm that changes the mode of the specific part TA. In step S23, the transparency setting unit 19 outputs the position information A1 and size information A3 of the specific part TA as well as the changed mode information A2 of the specific part TA to the transparency processing unit 21.

Also, when executing control in which the size of the specific part TA changes, in step S21, the transparency setting unit 19 changes the size information A3 of the specific part TA according to an algorithm that changes the size of the specific part TA. In step S23, the transparency setting unit 19 outputs the position information A1 and mode information A2 of the specific part TA as well as the changed size information A3 of the specific part TA to the transparency processing unit 21.

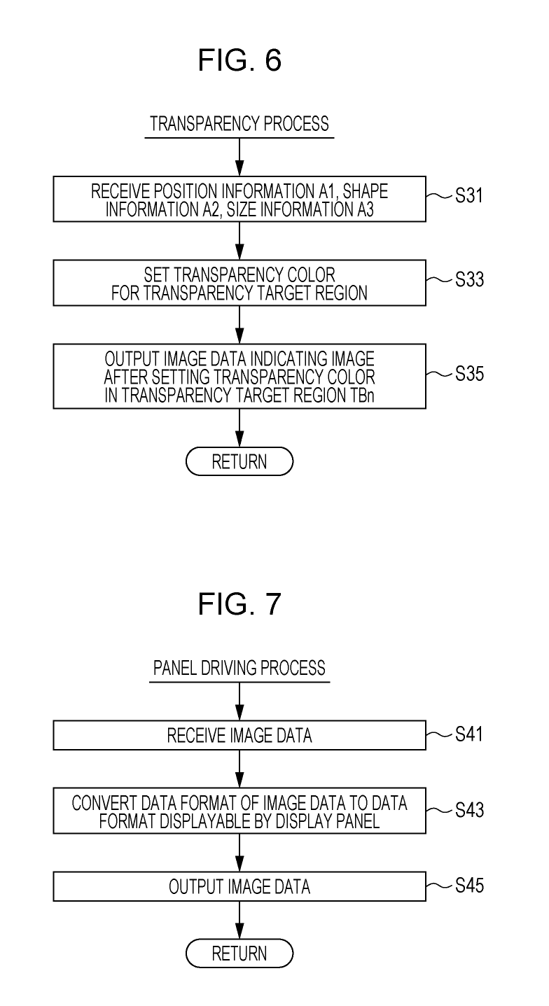

Next, FIGS. 3 and 6 will be referenced to describe step S5 of FIG. 4. FIG. 6 is a flowchart illustrating the transparency process in step S5 of FIG. 4. As illustrated in FIG. 6, the transparency process includes steps S31 to S35.

As illustrated in FIGS. 3 and 6, in step S31, the transparency processing unit 21 receives the position information A1, the mode information A2, and the size information A3 of the specific part TA from the transparency setting unit 19.

In step S33, the transparency processing unit 21 prescribes the specific part TA according to the position information A1, the mode information A2, and the size information A3, and in the image indicated by the image signal from the image signal processing unit 17, sets a region corresponding to the specific part TA, that is, the transparency target region, to a transparent color. In other words, the transparency processing unit 21 processes the transparency target region such that the transparency target region becomes transparent. For example, in the case in which the display panel 5 is a device that transmissively displays black regions of the display panel 5, the transparency processing unit 21 fills the transparency target region with a black color as the transparency process. Filling with a black color corresponds to setting the transparency target region to a transparent color. Note that the “image indicated by the image signal” refers to an overall image including the image IM and a background image of the image IM. The “image indicated by the image signal” has a rectangular shape.

In step S35, the transparency processing unit 21 outputs, to the panel driving unit 23, image data indicating an image after setting the transparency target region to a transparent color.

Next, FIGS. 3 and 7 will be referenced to describe step S7 of FIG. 4. FIG. 7 is a flowchart illustrating the panel driving process in step S7 of FIG. 4. As illustrated in FIG. 7, the panel driving process includes steps S41 to S45.

As illustrated in FIGS. 3 and 7, in step S41, the panel driving unit 23 receives image data indicating the image after setting the transparency target region to a transparent color from the transparency processing unit 21.

In step S43, the panel driving unit 23 converts the data format of the image data to a data format displayable by the display panel 5.

In step S45, the panel driving unit 23 outputs the image in the converted data format to the display panel 5. As a result, the display panel 5 displays an image indicated by the image data such that the specific part TA corresponding to the transparency target region is see-through.

### Embodiment 2

FIG. 3 and FIGS. 8A to 11 will be referenced to describe a display system 100 according to Embodiment 2 of the present disclosure. Embodiment 2 principally differs from Embodiment 1 in that the display system 100 according to Embodiment 2 displays predetermined information adjacent to the specific part TA, the specific part TA is associated with an object (for example, a product), or the specific part TA is associated with an image IM. Hereinafter, the points in Embodiment 2 that are different from Embodiment 1 will be described mostly. Also, since the configuration of the display system 100 according to Embodiment 2 is similar to the configuration of the display system 100 according to Embodiment 1, FIG. 3 will be referenced where appropriate.

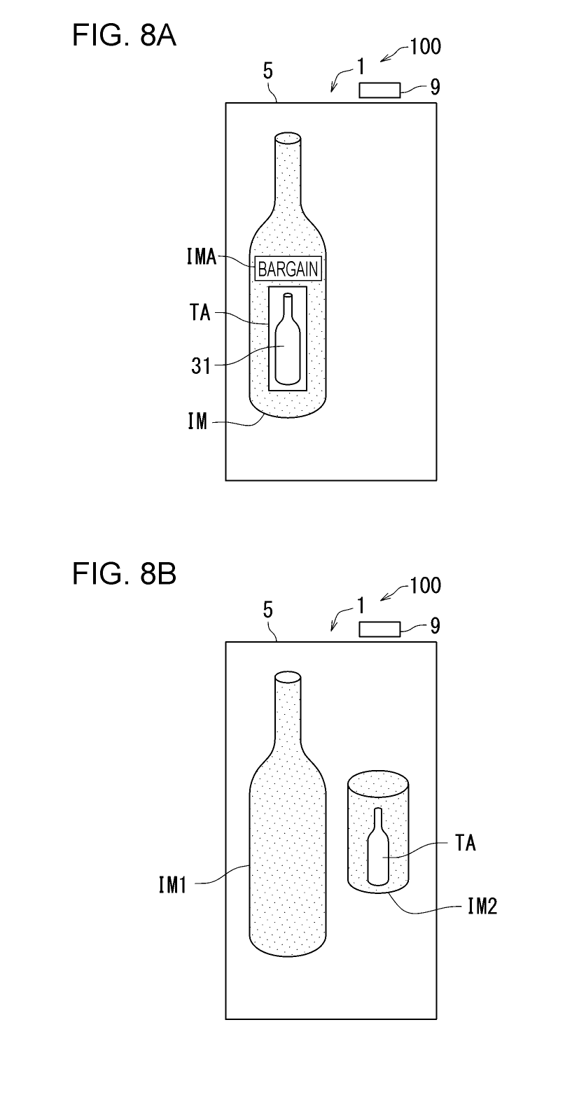

First, FIG. 8A will be referenced to describe an example operation of the display system 100 according to Embodiment 2. FIG. 8A is a diagram illustrating an example operation of the display system 100. As illustrated in FIG. 8A, the specific part TA is see-through. Consequently, similarly to Embodiment 1, the specific part TA functions as digital signage, and the function of the display panel 5 as digital signage may be improved.

Also, the controller 9 controls the display panel 5 to display the image IM together with predetermined information IMA (hereinafter designated “adjacent information IMA”) adjacent to the specific part TA of the display panel 5. The adjacent information IMA indicates an image or symbol to display adjacent to the specific part TA. The symbol may be letters (for example, the word “Bargain”), numbers, or a mark. The adjacent information IMA functions as a decorative image or a decorative symbol for decorating the specific part TA, for example.

As described above with reference to FIG. 8A, according to Embodiment 2, since the adjacent information IMA is displayed adjacent to the specific part TA, the attention of a human being may be further drawn to the specific part TA. Consequently, the sight line of the human being may be guided to the specific part TA more effectively.

Also, the controller 9 sets at least one of the position and mode of the specific part TA in correspondence with an object 31 facing the display panel 5. Consequently, a human being is able to look through the specific part TA and see the object 31 easily. The object 31 refers to an object positioned on the back side of the display panel 5, or in other words, an object (for example, a product) housed in the body 3 (FIG. 1). Specifically, the controller 9 sets at least one of the position and mode of the specific part TA in correspondence with the object 31 facing the back face from among the front face and the back face of the display panel 5.

According to Embodiment 2, since the specific part TA is associated with the object 31, the attention of a human being may be drawn to the object 31 through the specific part TA. Consequently, the sight line of the human being may be guided to the object 31 effectively. Particularly, by setting the adjacent information IMA to information related to the object 31, the sight line of the human being may be guided to the object 31 even more effectively. The “information related to the object 31” is, for example, information indicating the place of origin, quality, raw material, efficacy, or price of the object 31, or alternatively, information that indicates the place of origin, quality, raw material, efficacy, or price of the object 31 indirectly (for example, “Bargain”). The adjacent information IMA functions as a decorative image or a decorative symbol for decorating the object 31, for example.

For example, the controller 9 sets at least one of the position, mode, and size of the specific part TA such that any or all of the specific part TA faces opposite the object 31 facing the display panel 5.

For example, the controller 9 sets the position of the specific part TA such that the position of the specific part TA corresponds to the position of the object 31 facing the display panel 5. The position of the specific part TA corresponding to the position of the object 31 may be that the position of the specific part TA approximately matches or is close to the position of the object 31, for example.

For example, the controller 9 sets the mode of the specific part TA such that the mode of the specific part TA corresponds to a mode of the object 31 facing the display panel 5. The mode of the specific part TA corresponding to the mode of the object 31 may be that the mode of the specific part TA approximately matches the mode of the object 31, for example. Also, the mode of the specific part TA corresponding to the mode of the object 31 may be that the shape of the specific part TA approximately matches a shape expressing an outline shape of the object 31, for example. The “shape expressing an outline shape of the object 31” is a “longitudinal rectangular shape” in the case in which the object 31 is a beer bottle, for example.

For example, the controller 9 sets the size of the specific part TA such that the size of the specific part TA corresponds to the size of the object 31 facing the display panel 5. The size of the specific part TA corresponding to the size of the object 31 may be that the size of the specific part TA approximately matches the size of the object 31, for example. The size of the specific part TA corresponding to the size of the object 31 may also be that the size of the shape of the specific part TA approximately matches the size of a shape expressing an outline shape of the object 31, for example.

Next, FIG. 8B will be referenced to describe another example operation of the display system 100. FIG. 8B is a diagram illustrating another example operation of the display system 100. As illustrated in FIG. 8B, the display panel 5 display an image IM1 and an image IM2, for example. Additionally, the controller 9 sets the mode of the specific part TA in correspondence with the image IM1 displayed on the display panel 5.

Consequently, according to Embodiment 2, by the combined effect of the image IM1 and the mode of the specific part TA, the function of the display panel 5 as digital signage may be improved further.

For example, the controller 9 sets the mode of the specific part TA such that the mode of the specific part TA corresponds to a mode of the image IM1. The mode of the specific part TA corresponding to the mode of the image IM1 is that the mode of the specific part TA approximately matches the mode of the image IM1, for example.

Note that, in addition to the image IM1 and the image IM2, the controller 9 may also control the display panel 5 to display the adjacent information IMA adjacent to the specific part TA of the display panel 5.

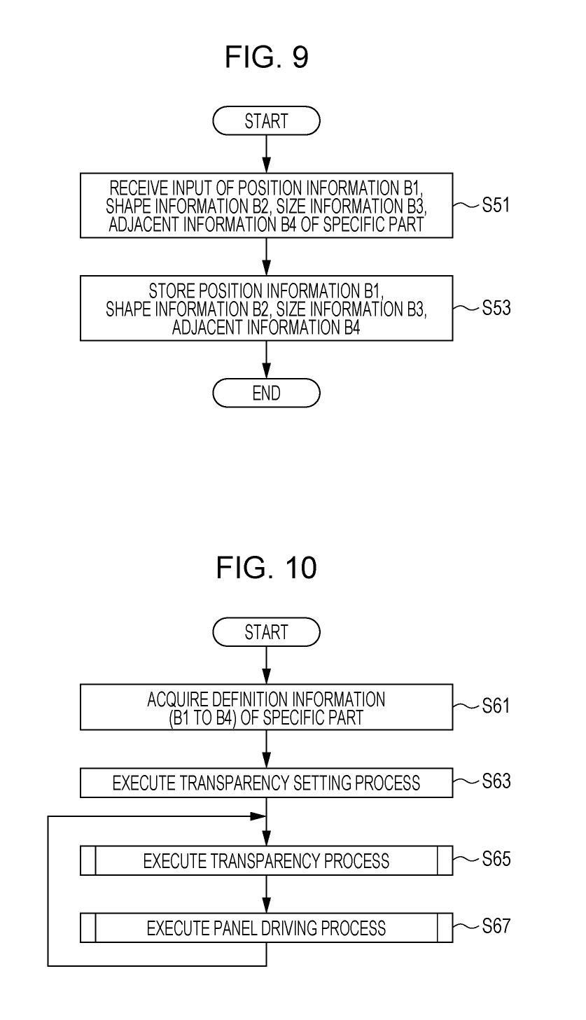

Next, FIGS. 3 and 9 will be referenced to describe a process when the input of definition information about the specific part TA is received from a user. FIG. 9 is a flowchart illustrating a process when the display device 1 receives input from a user. As illustrated in FIG. 9, the process includes steps S51 and S53.

As illustrated in FIGS. 3 and 9, in step S51, the input unit 15 receives the input of any or all of the information from among position information B1, mode information B2, and size information B3 about the specific part TA, and adjacent information IMA with respect to the specific part TA (hereinafter designated “adjacent information B4”) from a user as definition information about the specific part TA. Subsequently, the input unit 15 outputs an input signal including any or all of the information from among the position information B1, the mode information B2, the size information B3, and the adjacent information B4 to the input information processing unit 16.

For example, the display panel 5 displays an on-screen display (OSD) menu. Subsequently, the position information B1, the mode information B2, the size information B3, and/or the adjacent information B4 are input through the input unit 15 by input and a control command with respect to the OSD menu. Additionally, for example, the input unit 15 may also be a removable medium such as USB memory. Furthermore, the removable medium may be connected to the display device 1, and the position information B1, the mode information B2, the size information B3, and/or the adjacent information B4 may be input from the removable medium.

In step S53, from the input signal output by the input unit 15, the input information processing unit 16 extracts information included in the input signal from among the position information B1, the mode information B2, the size information B3, and the adjacent information B4. Subsequently, the input information processing unit 16 converts the data format of the extracted information to a data format usable by the transparency setting unit 19. In addition, the input information processing unit 16 controls the storage unit 13 to store the information in the converted data format. As a result, the storage unit 13 stores the information included in the input signal from among the position information B1, the mode information B2, the size information B3, and the adjacent information B4.

As described above with reference to FIG. 9, according to Embodiment 2, the user is able to set the position information, mode information, size information, and adjacent information about the specific part TA to the desired position information B1, mode information B2, size information B3, and adjacent information B4.

For example, the user is able to set the position information B1, the mode information B2, the size information B3, and the adjacent information B4 of the specific part TA in correspondence with a desired object among the objects (for example, products) housed in the body 3. Alternatively, for example, the user is able to set the position information B1, the mode information B2, the size information B3, and the adjacent information B4 of the specific part TA in correspondence with the image IM1 or the image IM2.

Next, FIGS. 3, 7, and 10 will be referenced to describe a control method executed by the controller 9 of the display device 1. FIG. 10 is a flowchart illustrating the control method. As illustrated in FIG. 10, the control method includes steps S61 to S67. For example, a computer program stored in the storage unit 13 causes the controller 9 to execute the control method.

In step S61, the transparency setting unit 19 acquires definition information about the specific part TA from the storage unit 13. Specifically, the definition information about the specific part TA includes the position information B1, mode information B2, size information B3, and adjacent information B4 stored in step S53 of FIG. 9.

In step S63, the transparency setting unit 19 executes the transparency setting process. Specifically, the transparency setting unit 19 outputs the position information B1, the mode information B2, the size information B3, and the adjacent information B4 to the transparency processing unit 21. Step S63 corresponds to “setting the specific part TA with respect to the display panel 5”, for example.

In step S65, the transparency processing unit 21 executes the transparency process. Specifically, similarly to Embodiment 1, the transparency processing unit 21 sets the transparency target region corresponding to the specific part TA to a transparent color. In addition, the transparency processing unit 21 disposes the adjacent information B4 adjacent to the transparency target region. Step S65 corresponds to “controlling the display panel 5 such that the specific part TA of the display panel 5 is see-through”, for example.

In step S67, the panel driving unit 23 executes the panel driving process. The panel driving process in step S67 is similar to the panel driving process illustrated in FIG. 7. After step S67, the process proceeds to step S65.

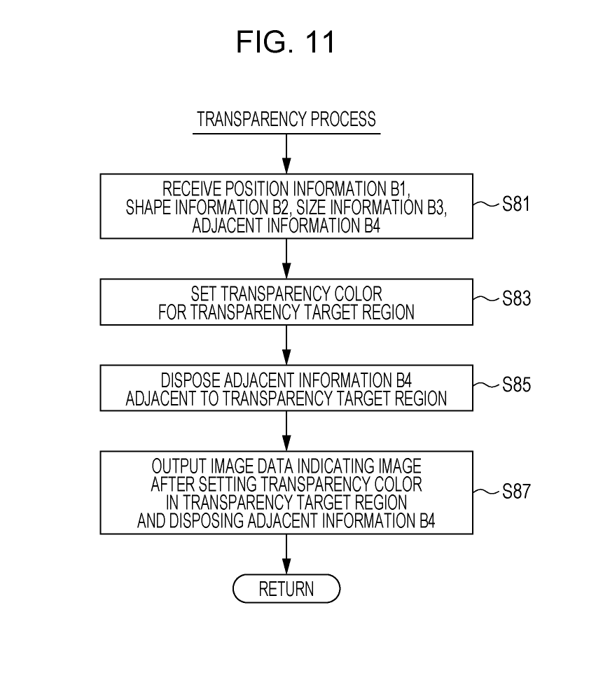

Next, FIGS. 3 and 11 will be referenced to describe step S65 of FIG. 10. FIG. 11 is a flowchart illustrating the transparency process in step S65 of FIG. 10. As illustrated in FIG. 11, the transparency process includes steps S81 to S87.

As illustrated in FIGS. 3 and 11, in step S81, the transparency processing unit 21 receives the position information B1, the mode information B2, the size information B3, and the adjacent information B4 of the specific part TA from the transparency setting unit 19.

In step S83, the transparency processing unit 21 prescribes the specific part TA according to the position information B1, the mode information B2, and the size information B3, and similarly to Embodiment 1, in the image (hereinafter designated the “image IMG”) indicated by the image signal from the image signal processing unit 17, sets a region corresponding to the specific part TA, that is, the transparency target region, to a transparent color. Note that the “image IMG indicated by the image signal” refers to an overall image including the image IM and a background image of the image IM. The “image IMG indicated by the image signal” has a rectangular shape.

In step S85, the transparency processing unit 21 disposes the adjacent information B4 adjacent to the transparency target region on the image IMG in which the transparency target region is set to a transparent color.

In step S87, the transparency processing unit 21 outputs, to the panel driving unit 23, image data indicating the image IMG after setting the transparency target region to a transparent color and disposing the adjacent information B4.

### Embodiment 3

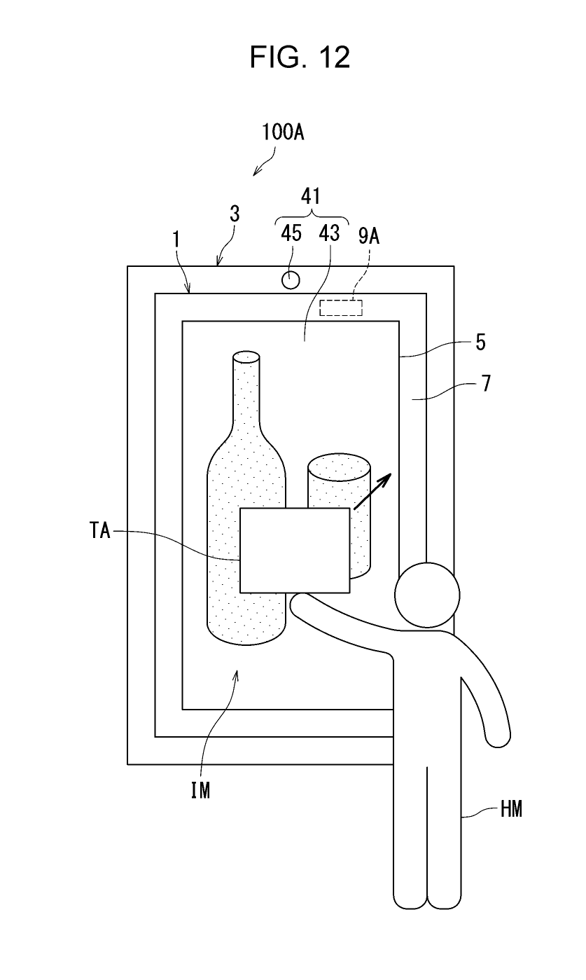

FIGS. 12 to 16 will be referenced to describe a display system 100A according to Embodiment 3 of the present disclosure. Embodiment 3 principally differs from Embodiment 1 in that the display system 100A according to Embodiment 3 changes the specific part TA in response to a gesture. Hereinafter, the points in Embodiment 3 that are different from Embodiment 1 will be described mostly.

First, FIG. 12 will be referenced to describe an example operation of the display system 100A. FIG. 12 is a diagram illustrating an example operation of the display system 100A. As illustrated in FIG. 12, similarly to Embodiment 1, the specific part TA is see-through. Consequently, similarly to Embodiment 1, the specific part TA functions as digital signage, and the function of the display panel 5 as digital signage may be improved.

Also, the display device 1 of the display system 100A includes a controller 9A instead of the controller 9 according to Embodiment 1. The controller 9A controls the display panel 5 such that at least one of the position, mode, and size of the specific part TA of the display panel 5 changes in response to a gesture. Consequently, the specific part TA moves, enlarges, and reduces in response to gestures. Alternatively, the mode of the specific part TA changes in response to gestures. The gestures include gestures performed with the fingers, hands, or arms, for example.

As described above with reference to FIG. 12, according to Embodiment 3, with a gesture, the human being HM is able to change at least one of the position, mode, and size of the specific part TA to move the specific part TA to a desired position, change the specific part TA to a desired mode, and change the specific part TA to a desired size. Consequently, convenience is improved for the human being HM. For example, the human being HM is able to change at least one of the position, mode, and size of the specific part TA such that a desired object is visible from among various objects positioned on the back side of the display panel 5.

Specifically, as illustrated in FIG. 12, the display system 100A preferably is also provided with a detection unit 41 in addition to the configuration of the display system 100 according to Embodiment 1. The detection unit 41 detects a body to be detected. Typically, the body to be detected is the human being HM. Hereinafter, the body to be detected will be designated the “detection target HM”.

The controller 9A specifies a gesture performed by the detection target HM from among multiple types of gestures on the basis of a detection result of the detection unit 41. Subsequently, the controller 9A controls the display panel 5 such that at least one of the position, mode, and size of the specific part TA of the display panel 5 changes in response to the gesture by the detection target HM.

Specifically, the detection unit 41 includes a touch detection unit 43 and an imaging unit 45. The touch detection unit 43 detects the touch position of the detection target HM with respect to the display screen of the display panel 5. The touch detection unit 43 is a touch panel, for example. The touch detection unit 43 is installed onto the display panel 5. Consequently, among the display system 100A, the display device 1 includes the touch detection unit 43. Note that in the case in which the touch detection unit 43 is a touch panel, the touch detection unit 43 may be on-cell or in-cell.

The imaging unit 45 images the detection target HM. The imaging unit 45 is a camera, for example. The installation location of the imaging unit 45 is not particularly limited insofar as the location allows the imaging unit 45 to capture an overall image of the detection target HM. Accordingly, for example, the imaging unit 45 is installed on a top front edge of the body 3.

The controller 9A specifies a gesture performed by the detection target HM from among multiple types of gestures on the basis of a detection result of the detection unit 41 or an imaging result of the imaging unit 45.

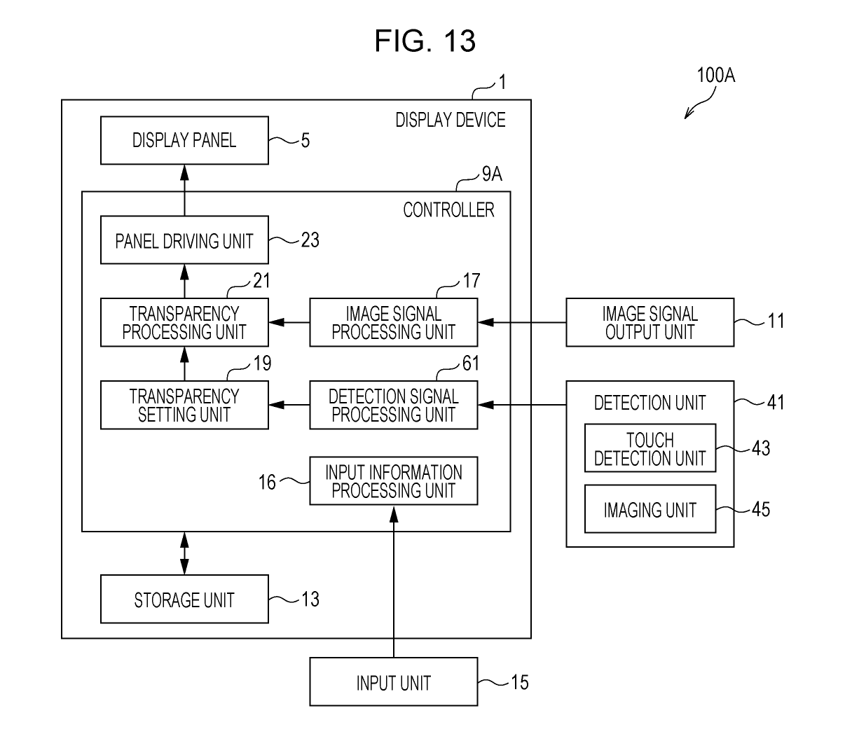

Next, FIG. 13 will be referenced to describe the display system 100A. FIG. 13 is a function block diagram illustrating the display system 100A. As illustrated in FIG. 13, the detection unit 41 detects the detection target HM, and outputs a detection signal of the detection target HM to the controller 9A on a fixed time interval. Specifically, the touch detection unit 43 detects a touch position with respect to the display screen of the display panel 5, and outputs a touch detection signal to the controller 9A as a detection signal. The imaging unit 45 images the detection target HM and outputs an imaging signal to the controller 9A as a detection signal.

The controller 9A also includes a detection signal processing unit 61 in addition to the configuration of the controller 9 according to Embodiment 1.

The detection signal processing unit 61 receives the touch detection signal or the imaging signal from the detection unit 41. Subsequently, the detection signal processing unit 61 specifies a gesture of the detection target HM on the basis of the touch detection signal or the imaging signal. Subsequently, the detection signal processing unit 61 outputs information indicating the gesture to the transparency setting unit 19.

The transparency setting unit 19 computes the position, mode, and size of the specific part TA on the basis of the gesture of the detection target HM. Additionally, the transparency setting unit 19 outputs position information, mode information, and size information about the specific part TA to the transparency processing unit 21.

Note that the operations of the transparency processing unit 21, the panel driving unit 23, and the image signal processing unit 17 are similar to the operations of the transparency processing unit 21, the panel driving unit 23, and the image signal processing unit 17 according to Embodiment 1, respectively.

Also, the controller 9A includes an image processing circuit, a display driver, and a processor, for example. Also, by executing computer programs stored in the storage unit 13, the processor functions as the transparency setting unit 19, the transparency processing unit 21, and the detection signal processing unit 61. Also, the controller 9A constitutes a computer.

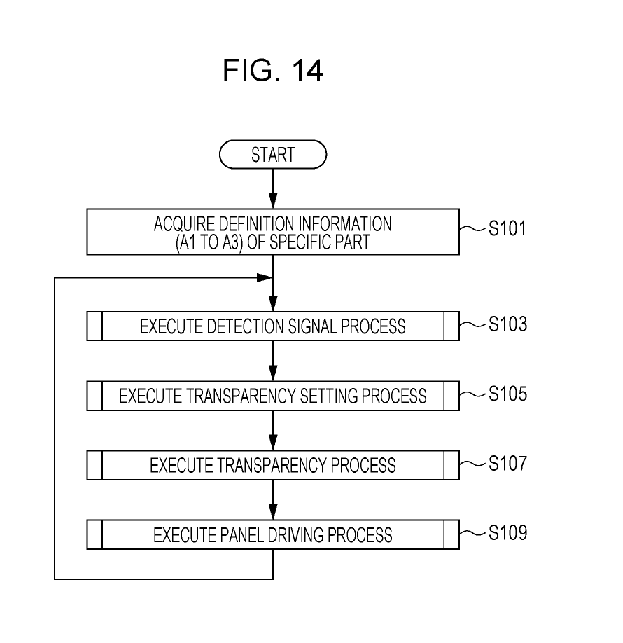

Next, FIGS. 13 and 14 will be referenced to describe a control method executed by the controller 9A of the display device 1. FIG. 14 is a flowchart illustrating the control method. As illustrated in FIG. 14, the control method includes steps S101 to S109. For example, a computer program stored in the storage unit 13 causes the controller 9A to execute the control method.

As illustrated in FIGS. 13 and 14, in step S101, similarly to Embodiment 1, the transparency setting unit 19 acquires the position information A1, the mode information A2, and the size information A3 about the specific part TA as definition information about the specific part TA from the storage unit 13. As an initial setting of the specific part TA prescribed by the position information A1, the mode information A2, and the size information A3, the display panel 5 displays the image IM such that the specific part TA is see-through.

In step S103, the detection signal processing unit 61 executes the detection signal process. In step S105, the transparency setting unit 19 executes the transparency setting process. Step S105 corresponds to “setting the specific part TA with respect to the display panel 5”, for example. In step S107, the transparency processing unit 21 executes the transparency process. Step S107 corresponds to “controlling the display panel 5 such that the specific part TA of the display panel 5 is see-through”, for example. In step S109, the panel driving unit 23 executes the panel driving process. The transparency process in step S107 and the panel driving process in step S109 are similar to the transparency process illustrated in FIG. 6 and the panel driving process illustrated in FIG. 7, respectively.

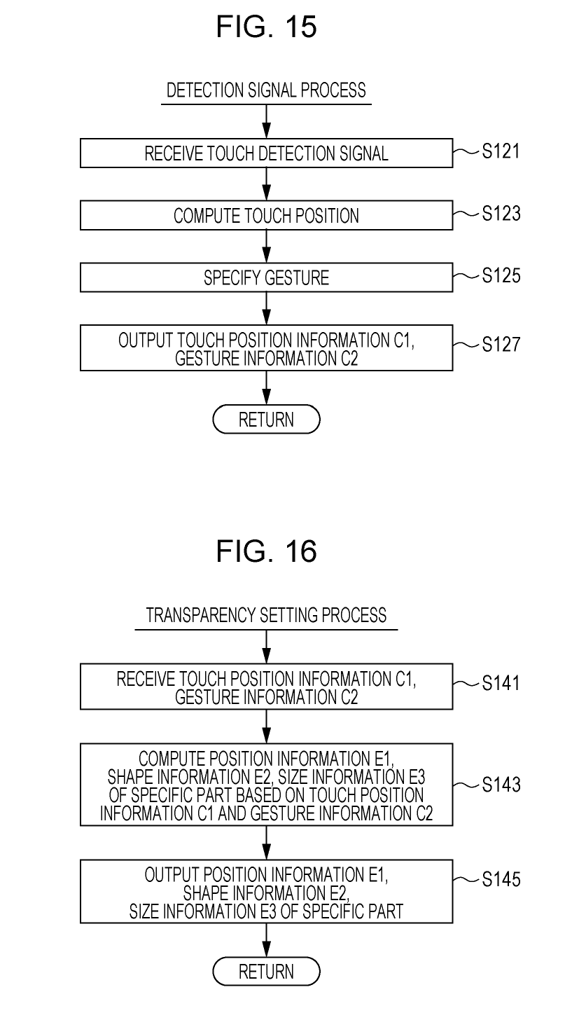

Next, FIGS. 13 and 15 will be referenced to describe step S103 of FIG. 14. FIG. 15 is a flowchart illustrating the detection signal process in step S103 of FIG. 14. FIG. 15 illustrates the detection signal process when specifying a gesture on the basis of the touch detection signal from the touch detection unit 43.

As illustrated in FIG. 15, in step S121, the detection signal processing unit 61 receives the touch detection signal from the touch detection unit 43.

In step S123, the detection signal processing unit 61 computes the touch position of the detection target HM with respect to the display screen of the display panel 5 on the basis of the touch detection signal.

In step S125, the detection signal processing unit 61 specifies a gesture by a touch operation of the detection target HM from among multiple types of gestures on the basis of a history of the touch position.

In step S127, the detection signal processing unit 61 outputs information C1 indicating the touch position (hereinafter designated the “touch position information C1”), and information C2 indicating the gesture (hereinafter designated the “gesture information C2”) to the transparency setting unit 19.

Note that in the detection signal process when specifying a gesture on the basis of the imaging signal from the imaging unit 45, in step S121, the detection signal processing unit 61 receives the imaging signal from the imaging unit 45. In step S123, the detection signal processing unit 61 computes a position of a hand in midair of the detection target HM on the basis of the imaging signal. In step S125, the detection signal processing unit 61 specifies a gesture by the hand of the detection target HM from among multiple types of gestures on the basis of a history of the hand position. In step S127, the detection signal processing unit 61 outputs information C3 indicating the hand position (not illustrated; hereinafter designated the “hand position information C3”), and information C4 indicating the gesture (not illustrated; hereinafter designated the “gesture information C4”) to the transparency setting unit 19.

Next, FIGS. 13 and 16 will be referenced to describe step S105 of FIG. 14. FIG. 16 is a flowchart illustrating the transparency setting process in step S105 of FIG. 14. As illustrated in FIG. 16, in step S141, the transparency setting unit 19 receives the touch position information C1 and the gesture information C2 from the detection signal processing unit 61.

In step S143, the transparency setting unit 19 computes position information E1, mode information E2, and size information E3 about the specific part TA on the basis of the touch position information C1 and the gesture information C2.

In step S145, the transparency setting unit 19 outputs the position information E1, the mode information E2, and the size information E3 about the specific part TA to the transparency processing unit 21.

Note that in the transparency setting process when specifying a gesture on the basis of the imaging signal from the imaging unit 45, in step S141, the transparency setting unit 19 receives the hand position information C3 and the gesture information C4 from the detection signal processing unit 61. In step S143, the transparency setting unit 19 computes the position information E1, the mode information E2, and the size information E3 of the specific part TA on the basis of the hand position information C3 and the gesture information C4.

### Embodiment 4

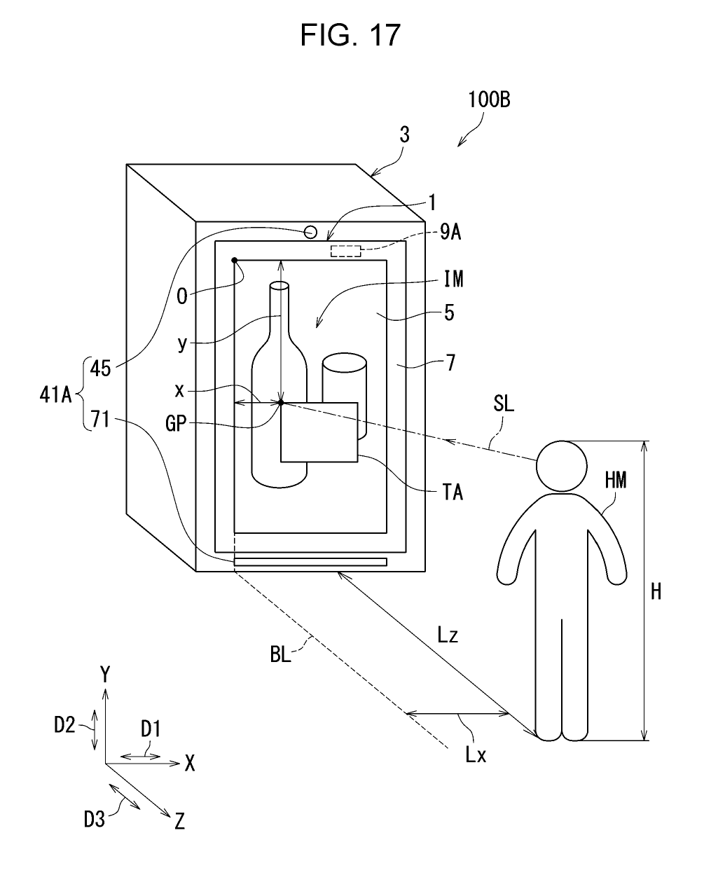

FIGS. 17 to 21 will be referenced to describe a display system 100B according to Embodiment 4 of the present disclosure. Embodiment 4 principally differs from Embodiment 1 and Embodiment 3 in that the display system 100B according to Embodiment 4 decides the position of the specific part TA according to a sight line. Hereinafter, the points in Embodiment 4 that are different from Embodiment 1 and Embodiment 3 will be described mostly.

First, FIG. 17 will be referenced to describe an example operation of the display system 100B according to Embodiment 4. FIG. 17 is a diagram illustrating an example operation of the display system 100B. As illustrated in FIG. 17, similarly to Embodiment 1, the specific part TA is see-through. Consequently, similarly to Embodiment 1, the specific part TA functions as digital signage, and the function of the display panel 5 as digital signage may be improved.

Also, the controller 9A of the display device 1 sets the position of the specific part TA of the display panel 5 on the basis of a sight line SL. Consequently, according to Embodiment 4, the position of the specific part TA may be set to a position corresponding to the sight line SL of a human being HM. As a result, the human being HM is able to look through the specific part TA and see an object positioned on the back side of the display panel 5 easily. Also, by simply moving one's sight line SL, the human being HM is able to change the position of the specific part TA. As a result, convenience is improved for the human being HM.

Specifically, as illustrated in FIG. 17, the display system 100B is provided with a detection unit 41A instead of the detection unit 41 of the display system 100A according to Embodiment 3. The detection unit 41A detects a body to be detected. Typically, the body to be detected is the human being HM. Hereinafter, the body to be detected will be designated the “detection target HM”.

The detection unit 41A includes an imaging unit 45 similar to the imaging unit 45 according to Embodiment 3. The controller 9A computes a sight line SL (specifically, a sight direction) of the detection target HM on the basis of an imaging result from the imaging unit 45. For example, the controller 9A computes the sight line SL of the detection target HM by executing eye tracking technology (for example, a corneal reflection method, a dark pupil method, or a bright pupil method). Subsequently, the controller 9A sets the position of the specific part TA on the basis of the sight line SL of the detection target HM. The position of the specific part TA is indicated by the coordinates (x, y), similarly to Embodiment 1. The coordinate “x” indicates the position in the first direction D1 on the display panel 5. The first direction D1 indicates a direction approximately parallel to the bottom edge or the top edge of the display panel 5. The coordinate “y” indicates the position in a second direction D2 on the display panel 5. The second direction D2 indicates a direction approximately parallel to the side edges of the display panel 5.

The detection unit 41A preferably additionally includes a ranging unit 71. The installation location of the ranging unit 71 is not particularly limited insofar as the location allows the ranging unit 71 to detect the distance Lz between the display device 1 and the detection target HM. Accordingly, for example, the ranging unit 71 is installed on a bottom front edge of the body 3, extending along the first direction D1. The ranging unit 71 detects the distance of the detection target HM with respect to the display panel 5. The ranging unit 71 includes a range sensor, for example. The controller 9A computes the distance of the detection target HM with respect to the display panel 5 on the basis of a detection result from the ranging unit 71.

The controller 9A preferably computes a gaze point GP of the detection target HM on the basis of the distance of the detection target HM with respect to the display panel 5 and the sight line SL. The gaze point GP indicates the intersection point between the sight line SL and the display panel 5. Subsequently, the controller 9A preferably sets the position of the specific part TA on the basis of the gaze point GP of the detection target HM. For example, the controller 9A preferably sets the position of one corner of the specific part TA to the position of the gaze point GP. For example, the controller 9A more preferably sets the center position of the specific part TA to the position of the gaze point GP.

The distance of the detection target HM with respect to the display panel 5 includes a distance Lz and a horizontal distance Lx. The distance Lz indicates the distance between the detection target HM and the display panel 5. The horizontal distance Lx indicates a distance along the first direction D1 of the detection target HM with respect to a baseline BL. The baseline BL is approximately parallel to a third direction D3. The third direction D3 indicates a direction approximately orthogonal to the display face of the display panel 5. Additionally, the baseline BL is approximately orthogonal to a side edge of the display panel 5.

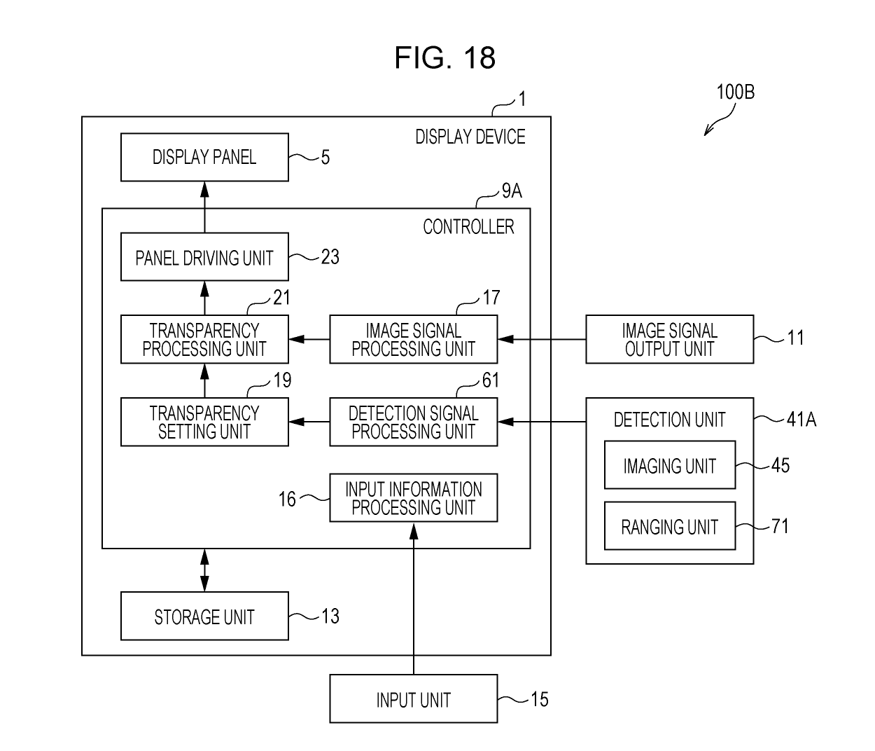

Next, FIG. 18 will be referenced to describe the display system 100B. FIG. 18 is a function block diagram illustrating the display system 100B. As illustrated in FIG. 18, the detection unit 41A detects the detection target HM, and outputs a detection signal of the detection target HM to the controller 9A on a fixed time interval.

Specifically, the imaging unit 45 images the detection target HM and outputs an imaging signal to the controller 9A as a detection signal. The ranging unit 71 detects the distance Lz, and outputs a first ranging signal to the controller 9A as a detection signal. Also, the ranging unit 71 detects the horizontal distance Lx, and outputs a second ranging signal to the controller 9A as a detection signal.

The detection signal processing unit 61 computes the sight line SL (for example, a sight line angle) of the detection target HM on the basis of the imaging signal. Also, the detection signal processing unit 61 computes the distance Lz on the basis of the first ranging signal, and computes the horizontal distance Lx on the basis of the second ranging signal. Additionally, the detection signal processing unit 61 outputs data indicating the horizontal distance Lx, the distance Lz, and the sight line SL to the transparency setting unit 19.

The transparency setting unit 19 computes the gaze point GP on the basis of the distance Lz, the horizontal distance Lx, and the sight line SL. Subsequently, the transparency setting unit 19 sets the position of the specific part TA on the basis of the gaze point GP of the detection target HM. Furthermore, the transparency setting unit 19 outputs position information, mode information, and size information about the specific part TA to the transparency processing unit 21.

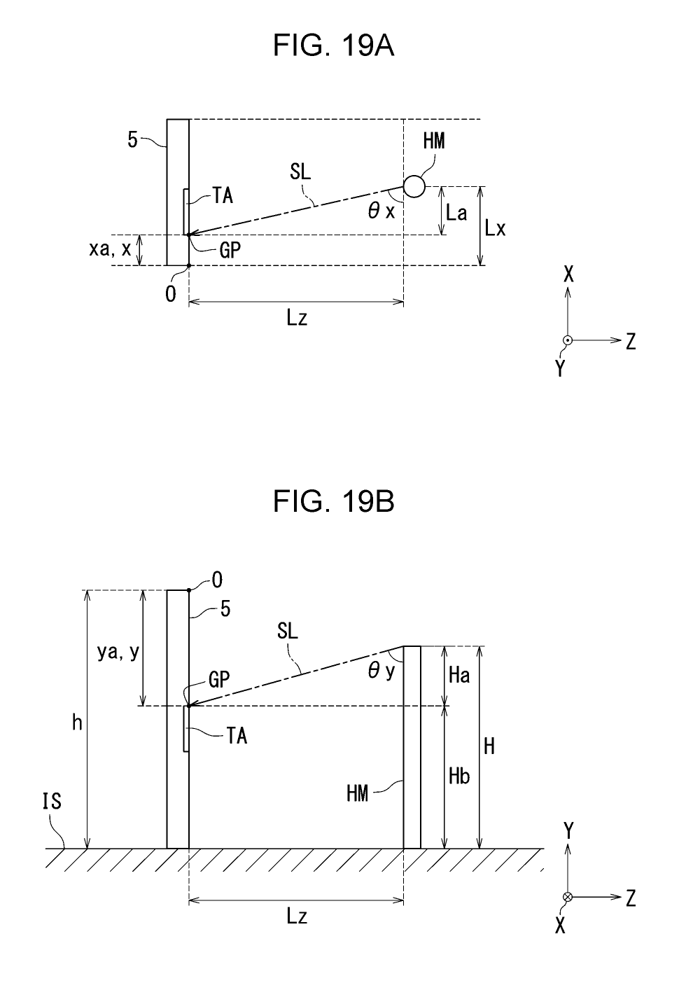

Next, FIGS. 18, 19A, and 19B will be referenced to describe a procedure for computing the gaze point GP based on the sight line SL. FIGS. 19A and 19B are diagrams illustrating the sight line SL of the detection target HM. In FIG. 19A, the display panel 5 and the detection target HM are seen from above the display panel 5 and the detection target HM. In FIG. 19B, the display panel 5 and the detection target HM are seen from the side of the display panel 5 and the detection target HM.

As illustrated in FIGS. 19A and 19B, the sight line SL is defined by a first sight line angle θx and a second sight line angle θy. The first sight line angle θx indicates an angle in the horizontal direction of the sight line SL. The second sight line angle θy indicates an angle in the vertical direction of the sight line SL.

Additionally, as illustrated in FIGS. 18, 19A, and 19B, the transparency setting unit 19 uses the horizontal distance Lx, the distance Lz, the first sight line angle θx, the height h of the display panel 5, the length H of the detection target HM, and the second sight line angle θy to compute coordinates (xa, ya) indicating the position of the gaze point GP according to Formulas (1) and (2). Additionally, the transparency setting unit 19 sets the coordinates (x, y) of the specific part TA to the coordinates (xa, ya) of the gaze point GP, for example.

xa=Lx−La=Lx−(Lz/tan θx) (1)

ya=h−Hb=h−(H−Ha)=h−(H−(Lz/tan θy)) (2)

The distance La in Formula (1) indicates the length of an adjacent side of the right triangle having the first sight line angle θx as an interior angle. The length of the opposite side of the right triangle matches the distance Lz. The distance Ha in Formula (2) indicates the length of an adjacent side of the right triangle having the second sight line angle θy as an interior angle. The length of the opposite side of the right triangle matches the distance Lz. The distance Hb in Formula (2) indicates the height of a gaze point with respect to the installation surface IS of the display panel 5.

The height h indicates the height of the display panel 5 with respect to the installation surface IS of the display panel 5. Note that the display panel 5 may be installed directly on the installation surface IS, or installed indirectly on the installation surface IS. The length H indicates the length (specifically, the height) in the vertical direction of the detection target HM.

Note that, as illustrated in FIGS. 18, 19A, and 19B, the detection signal processing unit 61 computes the first sight line angle θx and the second sight line angle θy used in Formulas (1) and (2) on the basis of the imaging signal from the imaging unit 45.

For example, the captured image indicated by the imaging signal includes an image of an eye of the human being acting as the detection target HM. Additionally, the detection signal processing unit 61 computes a motion vector of a moving point with respect to a reference point set in the eye in the captured image. The reference point is set to a center point of the iris when the eye is facing forward, for example. The moving point is a center point of the iris when the iris moves, for example. Additionally, the detection signal processing unit 61 decomposes the motion vector into a horizontal component and a vertical component. Furthermore, the detection signal processing unit 61 computes the first sight line angle θx on the basis of the horizontal component and a length Lh (not illustrated), and computes the second sight line angle θy on the basis of the vertical component and a length Lv (not illustrated). For example, the detection signal processing unit 61 sets the first sight line angle θx when the iris is positioned at the left edge of the eye to 0 degrees, sets the first sight line angle θx when the iris is positioned at the reference point to 90 degrees, and sets the first sight line angle θx when the iris is positioned at the right edge of the eye to 180 degrees. Also, the detection signal processing unit 61 sets the length Lh of the horizontal component when the iris is positioned at the right edge of the eye to “Lm”. Consequently, the first sight line angle θx when the iris is positioned between the reference point and the right edge of the eye becomes “90+(Lh/Lm)×90”.

Also, the distance Lz, the horizontal distance Lx, and the length H used in Formulas (1) and (2) are computed as follows.

Namely, as illustrated in FIG. 17, the ranging unit 71 detects the distance Lz between the detection target HM and the display panel 5 by irradiating the detection target HM with light waves or sound waves, and receiving the light waves or sound waves reflected by the detection target HM. Consequently, the distance Lz is expressed by the distance between the detection target HM and the ranging unit 71. The ranging unit 71 outputs a first ranging signal corresponding to the distance Lz to the detection signal processing unit 61. The detection signal processing unit 61 computes the distance Lz on the basis of the first ranging signal.

For example, the ranging unit 71 and the detection signal processing unit 61 are configured in accordance with the triangulation method, and execute processes in accordance with the triangulation method. Additionally, for example, the triangulation method utilizing light waves is a method of converting changes in the image formation position of the detection target HM on a light sensor caused by distance changes of the detection target HM into the distance Lz. Consequently, the ranging unit 71 includes a light emitter and a light sensor, and outputs a light detection signal of the light sensor as the first ranging signal. Subsequently, the detection signal processing unit 61 computes the distance Lz on the basis of the first ranging signal according to the triangulation method.

Also, for example, the ranging unit 71 detects the horizontal distance Lx by irradiating the detection target HM with light and receiving the light reflected by the detection target HM. The ranging unit 71 outputs a second ranging signal corresponding to the horizontal distance Lx to the detection signal processing unit 61. The detection signal processing unit 61 computes the horizontal distance Lx on the basis of the second ranging signal.

For example, the ranging unit 71 includes K optical sensors. Herein, “K” is an integer equal to or greater than 2. Each optical sensor includes a light emitter and a light sensor. The K optical sensors are disposed in a straight line along the first direction D1. Each optical sensor has a width W along the first direction D1. The ranging unit 71 outputs a light detection signal of the light sensor in each optical sensor as the second ranging signal. Subsequently, if from among the 1st to Kth optical sensors, the kth optical sensor from the side of the baseline BL detects the detection target HM, the detection signal processing unit 61 computes “k×W” as the horizontal distance Lx.

Also, the detection signal processing unit 61 computes the length H of the detection target HM on the basis of the imaging signal. For example, the detection signal processing unit 61 computes the length H of the detection target HM on the basis of the position of an apex (specifically, the top of the head) of the detection target HM included in the captured image and the distance Lz between the detection target HM and the display panel 5.

Next, FIGS. 14 and 18 will be referenced to describe a control method executed by the controller 9A of the display device 1. As illustrated in FIG. 14, the control method according to Embodiment 4 includes steps S101 to S109, similarly to Embodiment 3. Step S101 according to Embodiment 4 is similar to step S101 according to Embodiment 3. In step S103, the detection signal processing unit 61 executes the detection signal process. In step S105, the transparency setting unit 19 executes the transparency setting process. Step S107 and step S109 according to Embodiment 4 are similar to step S107 and step S109 according to Embodiment 3, respectively.

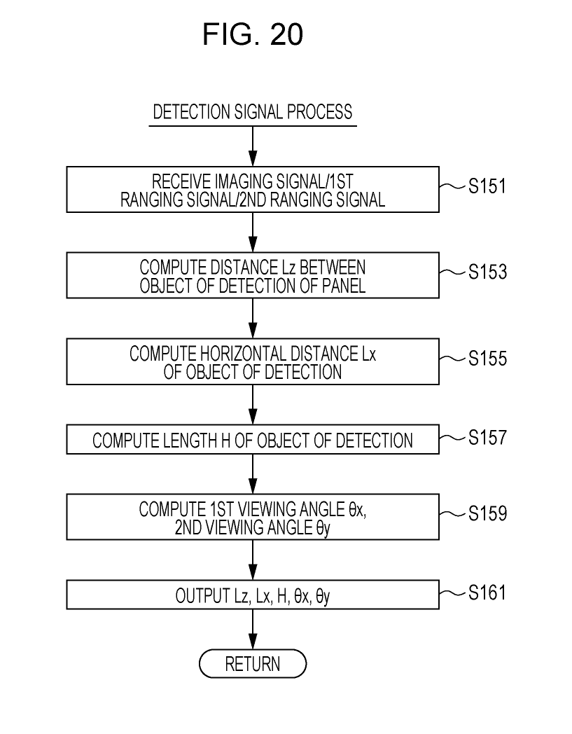

Next, FIGS. 18 and 20 will be referenced to describe step S103 of FIG. 14. FIG. 20 is a flowchart illustrating the detection signal process in step S103 of FIG. 14. As illustrated in FIG. 20, the detection signal process includes steps S151 to S161.

As illustrated in FIGS. 18 and 20, in step S151, the detection signal processing unit 61 receives the imaging signal from the imaging unit 45, and receives the first and second ranging signals from the ranging unit 71.

In step S153, the detection signal processing unit 61 computes the distance Lz between the detection target HM and the display panel 5 on the basis of the first ranging signal.

In step S155, the detection signal processing unit 61 computes the horizontal distance Lx of the detection target HM on the basis of the second ranging signal.

In step S157, the detection signal processing unit 61 computes the length H of the detection target HM on the basis of the imaging signal.

In step S159, the detection signal processing unit 61 computes the first sight line angle θx and the second sight line angle θy of the detection target HM on the basis of the imaging signal.

In step S161, the detection signal processing unit 61 outputs data indicating the distance Lz, the horizontal distance Lx, the length H, the first sight line angle θx, and the second sight line angle θy to the transparency setting unit 19.

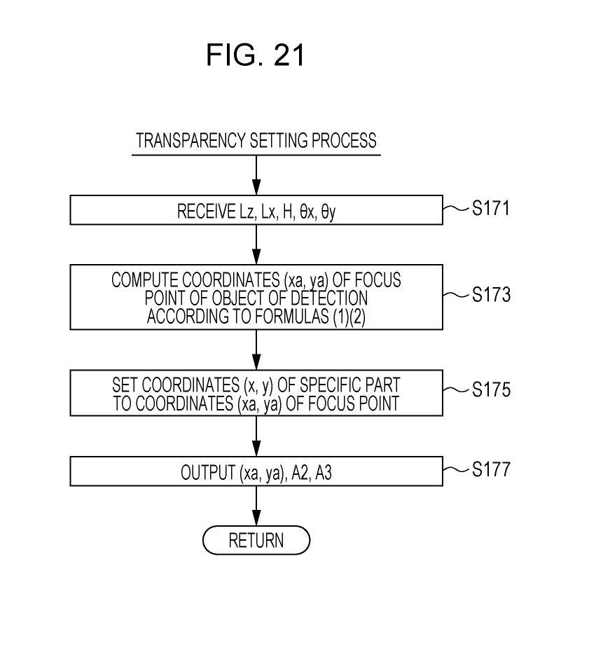

Next, FIGS. 18 and 21 will be referenced to describe step S105 of FIG. 14. FIG. 21 is a flowchart illustrating the transparency setting process in step S105 of FIG. 14. As illustrated in FIG. 21, the transparency setting process includes steps S171 to S177.

As illustrated in FIGS. 18 and 21, in step S171, the transparency setting unit 19 receives data indicating the distance Lz, the horizontal distance Lx, the length H, the first sight line angle θx, and the second sight line angle θy from the detection signal processing unit 61.

In step S173, the transparency setting unit 19 computes the coordinates (xa, ya) of the gaze point GP of the detection target HM according to Formulas (1) and (2).

In step S175, the transparency setting unit 19 sets the coordinates (x, y) of the specific part TA to the coordinates (xa, ya) of the gaze point GP.

In step S177, the transparency setting unit 19 outputs the coordinates (xa, ya) indicating the position information of the specific part TA as well as the mode information A2 and the size information A3 of the specific part TA to the transparency processing unit 21.

The above describes embodiments of the present disclosure with reference to the drawings. However, the present disclosure is not limited to the above embodiments, and may be carried out in various modes in a range that does not depart from the gist of the present disclosure (for example, (1) to (4) illustrated below). Also, various modifications of the present disclosure are possible by appropriately combining the multiple structural elements disclosed in the above embodiments. For example, several structural elements may be removed from among all of the structural elements illustrated in the embodiments. Furthermore, structural elements across different embodiments may be combined appropriately. The drawings schematically illustrate each of the structural elements as components for the sake of understanding, but in some cases, the thicknesses, lengths, numbers, intervals, and the like of each illustrated structural element may be different from actuality for the sake of convenience in the creation of the drawings. Also, the materials, shapes, dimensions, and the like of each structural element illustrated in the above embodiments are one example and not particularly limiting, and various modifications are possible within a range that does not depart substantially from the effects of the present disclosure.

(1) It is possible to combine some or all of the characteristics of the specific part TA of Embodiment 1 (change in position, mode, or size), the characteristics of the specific part TA of Embodiment 2 (adjacent image, correspondence with object, or correspondence with image), the characteristics of the specific part TA of Embodiment 3 (change in response to gesture), and the characteristics of the specific part TA of Embodiment 4 (setting position according to sight line).

(2) In Embodiment 3, as long as it is possible to image the detection target HM, the installation position of the imaging unit 45 is not limited to being outside the display device 1. For example, the display device 1 may be provided with the imaging unit 45, and the imaging unit 45 may be installed in the display device 1. Also, in Embodiment 4, as long as the sight line SL, the distance Lz, the horizontal distance Lx, and the length H are detectable, the installation position of the detection unit 41A is not limited to being outside the display device 1. For example, the display device 1 may be provided with the detection unit 41A, and the detection unit 41A may be installed in the display device 1.

(3) In Embodiment 3, as long as it is possible to compute the touch position and specify a gesture, the controller 9A is not limited to computing the touch position and specifying a gesture. For example, the detection unit 41 may also compute the touch position and specify a gesture on the basis of a detection result of the detection unit 41. Also, as long as a gesture is detectable, it is sufficient for the display system 100A to be provided with either one of the touch detection unit 43 and the imaging unit 45. Also, in Embodiment 4, as long as the distance Lz, the horizontal distance Lx, the length H, the first sight line angle θx, and the second sight line angle θy are computable, the controller 9A is not limited to computing the distance Lz, the horizontal distance Lx, the length H, the first sight line angle θx, and the second sight line angle θy. For example, the detection unit 41A may also compute any or all of the distance Lz, the horizontal distance Lx, the length H, the first sight line angle θx, and the second sight line angle θy on the basis of a detection result from the detection unit 41A. In this case, the controller 9A acquires any or all of the distance Lz, the horizontal distance Lx, the length H, the first sight line angle θx, and the second sight line angle θy from the detection unit 41A.

(4) In Embodiments 1 to 4, the mode of the specific part TA is not limited to a rectangular shape, and may be set to any mode. Also, the body 3 may also not be provided.

The present disclosure provides a display device, a control method, and a non-transitory computer-readable recording medium, and has industrial applicability.

The present disclosure contains subject matter related to that disclosed in Japanese Priority Patent Application JP 2017-217075 filed in the Japan Patent Office on Nov. 10, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display panel that displays an image; and
a controller that controls the display panel such that a specific part of the display panel is see-through.

2. The display device according to claim 1, wherein
the controller controls the display panel such that at least one of a position, a mode, and a size of the specific part of the display panel changes.

3. The display device according to claim 1, wherein
the controller controls the display panel to display predetermined information adjacent to the specific part of the display panel.

4. The display device according to claim 1, wherein
the controller sets at least one of a position, a mode, and a size of the specific part in correspondence with an object facing the display panel.

5. The display device according to claim 1, wherein
the controller sets a mode of the specific part in correspondence with the image displayed on the display panel.

6. The display device according to claim 1, wherein
the controller controls the display panel such that at least one of a position, a mode, and a size of the specific part of the display panel changes in response to a gesture.

7. The display device according to claim 1, wherein
the controller sets a position of the specific part of the display panel on a basis of a sight line.

8. A control method comprising:
setting a specific part with respect to a display panel; and
controlling the display panel such that the specific part is see-through.

9. A non-transitory computer-readable recording medium storing a computer program causing a computer to execute a process comprising:
setting a specific part with respect to a display panel; and
controlling the display panel such that the specific part is see-through.
